(19) United States
(12) Patent Application Publication
(10) Pub. No.: US 2006/0126712 A1
(43) Pub. Date: Jun. 15, 2006

(54) Rate control protocol for long thin transmission channels

(76) Inventors: Alain Teil, Saint-Etienne (FR); Laurent Fay, La Frette sur Seine (FR)

Correspondence Address: PHILIPS INTELLECTUAL PROPERTY & STANDARDS, P.O. BOX 3001, BRIARCLIFF MANOR, NY, 10510, US

(21) Appl. No.: 10/525,455

(22) PCT Filed: Aug. 7, 2003
(86) PCT No.: PCT/IB03/03500

§ 371 Date: Feb. 23, 2005

(30) Foreign Application Priority Data
Aug. 28, 2002 (EP) 02292120.9

(51) Int. Cl. H04B 17/00; H04B 1/38

(52) U.S. Cl. 375/225; 375/221

(57) ABSTRACT

The invention deals with rate control protocols having a probing phase during which the sending rate of the transmitter is repeatedly increased until a loss is reported by the receiver. Such probing phases are used by the transmitter to quickly increase its sending rate to a fair share of the transmission channel bandwidth. According to the invention, a fake loss is generated by the receiver when the sending rate has risen to the current capacity of the transmission channel so as to force the transmitter to terminate the probing. Application: wireless Internet access to audio-video streaming services.

### FIELD OF THE INVENTION

The invention deals with a data transmission system comprising at least a transmitter having an adaptable sending rate, a transmission channel having a time varying capacity, and a receiver having data control means for detecting losses and feedback means for reporting said losses to the transmitter, said transmitter having probing means for probing the transmission channel by repeatedly raising its sending rate until a loss is reported by the receiver.

The invention also deals with a receiver to be used in such a transmission system.

The invention also deals with a rate control method to be used for transmitting data from a transmitter having an adaptable sending rate to a receiver designed for detecting losses and reporting losses to said transmitter, through a transmission channel having a time varying capacity, said rate control method comprising the step of repeatedly raising the sending rate of the transmitter for probing the transmission channel until a loss is reported by the receiver.

The invention also deals with a program comprising instructions for implementing the steps of said rate control method that are to be implemented at the receiver, when said program is executed by a processor.

### BACKGROUND OF THE INVENTION

Examples of such rate control methods can be found in the article “A survey on TCP-friendly congestion control” by J. Widmer, R. Denda and M. Mauve published in IEEE Network May/June 2001 pages 28 to 37.

For instance, in the TFRC protocol (TCP-Friendly Rate Control protocol), immediately after startup, the transmitter goes into a phase called “slow start” to quickly increase its sending rate to a fair share of the transmission channel bandwidth. Roughly the TFRC slow start consists in doubling the sending rate each RTT (Round Trip Time). The TFRC slow start is terminated with the first loss report.

Such TCP-friendly rate-based control protocols were designed for transmission of non-TCP traffic over the Internet, for instance for the transmission of audio/video streams.

An object of the invention is to propose a rate control method specifically adapted to the transmission of such non-TCP traffic over “long thin networks” so as to enable wireless Internet access to audio/video streaming services (long thin networks are defined in the RFC 2757 “Long Thin Networks” by G. Montenegro, S. Dawkins, M. Kojo, V. Magret and N. Vaidya, January 2000).

### SUMMARY OF THE INVENTION

This is achieved with a data transmission system, a receiver, a rate control method and a program as claimed in claims 1 to 8.

According to the invention, when the transmission channel is being probed by repeatedly raising the sending rate of the transmitter, a fake loss is reported by the receiver when the sending rate has risen to the current capacity of the transmission channel so as to force the transmitter to terminate the probing.

Long thin networks (wireless access links, satellite links, etc. . . . ) generally induce large Round Trip Times. Typically the Round Trip Time reaches some hundreds of milliseconds for a wired access to the Internet while it can reach several seconds for a wireless access. This prevents high reactivity. Especially, when the transmission channel is being probed by repeatedly raising the sending rate of the transmitter, there is a risk that the capacity of the transmission channel is exceeded, thereby generating additional losses because the feedback of the receiver is not received on time at the transmitter.

By reporting a fake loss when the sending rate of the transmitter has risen to the current capacity of the transmission channel, the invention overcomes this risk.

Advantageously, the receiver computes a received rate that is an estimation of the rate at which data are received, and it monitors the evolution of said received rate for deciding whether the sending rate has risen to the current capacity of the transmission channel.

At the beginning of the probing phase, the received rate increases with the sending rate. It starts to stabilize when the sending rate gets close to the current capacity of the transmission channel. Therefore, monitoring the evolution of the received rate gives an accurate indication of whether the sending rate has risen to the current capacity of the transmission channel.

### BRIEF DESCRIPTION OF THE DRAWINGS

These and other aspects of the invention will be further described with reference to the following drawings:

FIG. 1 is a schematic representation of an example of atransmission system according to the invention,

FIG. 2 is a schematic representation of the information that is exchanged in the TFRC protocol,

FIG. 3 is a block diagram of a rate control method according to the invention.

### DESCRIPTION OF A PREFERRED EMBODIMENT

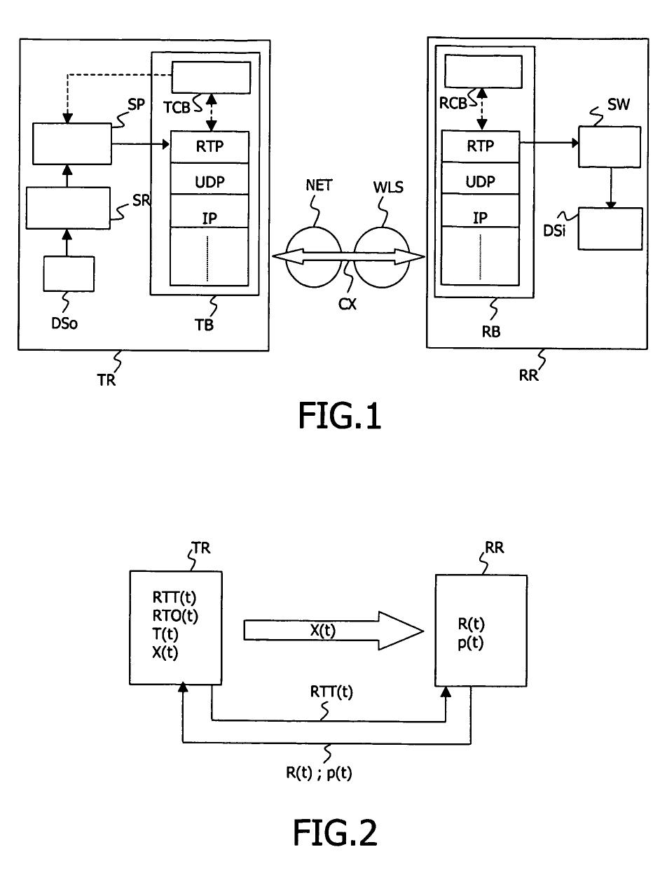

A transmission system according to the invention is represented in FIG. 1 by way of example. It comprises a transmitter TR, a transmission channel CX, and a receiver RR. In the described embodiment, the transmitter TR is a streaming server. The receiver RR is a mobile apparatus. The transmission channel CX is a long thin transmission channel through a packet transmission network NET (for instance the Internet network) and a radio access network WLS (for instance a network compliant with the GPRS or the UMTS standard). As the transmission channel CX uses shared resources, its capacity can vary in an unpredictable and potentially wide fashion. The transmission system described in FIG. 1 allows wireless access to audio/video streaming services provided by the server TR.

According to FIG. 1, the transmitter TR comprises a data source DSo, a stream reader SR, a shaper SP, and a transmission/reception block TB. The transmission/reception block TB implements the first four layers of the ISO protocol stack. In this example, the network protocol (ISO layer 3) is IP (Internet Protocol) and the transport protocol (ISO layer 4) is RTP (Real time Transfer Protocol) over UDP (User Datagram Protocol). As UDP is a transport protocol without rate control the transmission/reception block TB comprises a specific rate control block TCB. The aim of the rate control block TCB is to compute a target sending rate X(t) suited to the current capacity of the transmission channel CX. This target sending rate X(t) is sent to the shaper SP. The stream reader SR gets data packets of constant size from the data source DSo. The role of the shaper SP is to control the sending time of these data packets so as to enforce the target sending rate X(t) computed by the rate control block TCB. When delivered by the shaper SP, the data packets are forwarded to the transmission/reception block TB where they are processed according to the above-mentioned transport protocols in order to be transmitted over the transmission channel CX.

The receiver RR comprises a transmission/reception block RB and a stream writer SW. The transmission/reception block RB implements the first four layers of the ISO protocol stack and comprises a rate control block RCB, which functions will be described in more detail in the following of the description. The data packets received over the transmission channel CX are processed by the transmission/reception block RB. Then, they are written in a data sink DSi by the stream writer SW.

In the embodiment described here by way of example, the rate control blocks TCB and RCB implement a rate control method that is compliant with the current version of the TFRC rate control protocol. This is not restrictive: the invention may be used with any other protocol having a probing phase consisting of repeatedly raising the sending rate until a loss is reported by the receiver.

The current version of the TFRC rate control protocol is described in the IETF draft “TCP friendly rate control (TFRC): protocol specification” by M. Handley, J. Padhye S. Floyd and J. Widmer, published on Apr. 27, 2002 and expiring in October 2002.

FIG. 2 gives a representation of the information that is exchanged between the transmitter TR and the receiver RR according to the TFRC rate control protocol. As described in FIG. 2, the receiver RR computes a received rate R(t) and a loss indicator p(t). Both the received rate R(t) and the loss indicator p(t) are transmitted to the transmitter TR in a feedback report (feedback reports are sent from the receiver RR to the transmitter TR by using the RTP control protocol).

The received rate R(t) is an estimation of the rate at which the data have been received since the last feedback report.

The loss indicator p(t) is called loss event rate in TFRC. It is defined as the inverse of the average loss interval, where a loss interval is the number of received packets between two loss events, and a loss event is one or several packets lost within a time interval having the duration of the current Round Trip Time. More details about the computation of the loss event rate can be found in paragraph 5 of the TFRC draft.

When a feedback report is received, the transmitter TR computes a current Round Trip Time RTT(t) and a current Retransmission Time Out RTO(t). The current Retransmission Time Out RTO(t) is derived from the current Round Trip Time RTT(t). For computing the current Retransmission Time Out, TFRC uses the following approximation: RTO(t)=4×RTT(t)

From the current Round Trip Time RTT(t) and the current Retransmission Time Out RTO(t), the transmitter computes an allowed sending rate T(t). The equation to be used to compute the allowed sending rate is defined in paragraph 3.1 of the TFRC draft and is written as

$$T ( t ) = \frac{S}{RTT ( t ) \sqrt{\frac{2 p ( t )}{3}} + RTO ( t ) [ 3 \sqrt{\frac{3 p ( t )}{8}} p ( t ) ( 1 + 32 {p ( t )}^{2} ) ]}$$

where S is the mean size of the data packets in bytes.

Then the allowed sending rate T(t), the loss indicator p(t) and the received rate R(t) are used to compute the target sending rate X(t). The algorithm to be used for calculating the target sending rate X(t) is defined in paragraph 4.3 of the TFRC draft and is written as:

$$if p ( t ) > 0 , then X ( t ) = max \{ min ( T ( t ) ; 2 R ( t ) ) ; \frac{S}{64} \}$$

or if (Now−TimeLastDoubledDuringSlowStart≧RTT(t)), then

$$X ( t ) = max \{ min ( 2 X ( t - 1 ) ; 2 R ( t ) ) ; \frac{S}{RTT ( t )} \} ,$$

and TimeLastDoubledDuringSlowStart=Now.
“Now” is the time at which the transmitter receives the feedback packet.

Finally the current Round Trip Time RTT(t) is sent from the transmitter TR to the receiver RR because it is used by the receiver for computing the loss indicator p(t).

As can be seen from the above, the algorithm used to compute the target sending rate roughly consists in doubling the target sending rate every Round Trip Time when the loss indicator is equal to zero so as to probe the transmission channel CX.

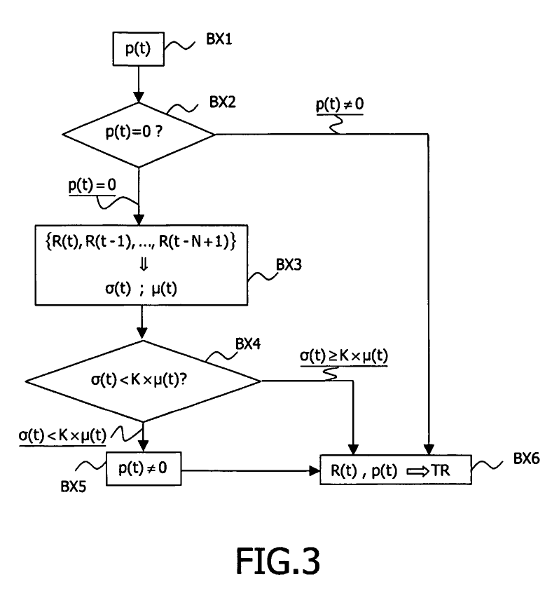

According to the invention, the receiver is designed to report a fake loss (p(t)≠0) when the sending rate has risen to the current capacity of the transmission channel CX so as to force the transmitter to terminate said probing. Advantageously with a view to determining if the sending rate has risen to the current capacity of the transmi, in ssion channel, the receiver advantageously monitors the evolution of the received rate R(t). A preferred embodiment is described in FIG. 3.

As indicated in box BX1, the loss indicator p(t) is computed by applying the computation rules indicated in the TFRC draft. Then, in box BX2, a test is performed. If p(t)=0, the execution is pursued as indicated in box BX3. If p(t)≠0, a feedback report is directly sent to the transmitter as indicated in box BX6. This feedback report comprises the loss indicator calculated in box BX1.

In box BX3, each time a new value R(t) of the received rate is computed, the receiver RR updates the standard deviation σ(t) and the mean value μ(t) of the last N values of the received rate {R(t), R(t−1), . . . , R(t−N+1)}. Then, in box BX4 a test is performed.

If σ(t)<K·μ(t) where K is a constant value, a fake error is generated in box BX5. For instance this is achieved by setting the loss indicator p(t) to a non-zero value. Then a feedback report is sent to the transmitter as indicated in box BX6. This feedback report comprises the loss indicator calculated in box BX5.

If σ(t)≧K·μ(t), a feedback report is directly sent to the transmitter as indicated in box BX6. This feedback report comprises the loss indicator calculated in box BX1.

For instance, K=0.05 and N=3.

With respect to the above-mentioned transmission system, receiver, rate control method and program, modifications or improvements may be proposed without departing from the scope of the invention. The invention is thus not limited to the examples provided.

In particular other or additional criteria may be used by the receiver for deciding if a fake loss has to be generated.

The word “comprising” does not exclude the presence of elements or steps other than those listed in the claims.

1. A data transmission system comprising at least a transmitter having an adaptable sending rate, a transmission channel having a time varying capacity, and a receiver having data control means for detecting losses and feedback means for reporting said losses to the transmitter, said transmitter having probing means for probing the transmission channel by repeatedly raising its sending rate until a loss is reported by the receiver, characterized in that said receiver is designed to report a fake loss when the sending rate has risen to the current capacity of the transmission channel so as to force the transmitter to terminate said probing.

2. A data transmission system as claimed in claim 1, characterized in that said receiver is further designed to compute a received rate that is an estimation of the rate at which data are received, and to monitor the evolution of said received rate for deciding whether the sending rate has risen to the current capacity of the transmission channel.

3. A data transmission system as claimed in claim 1 or 2, characterized in that said transmitter comprises rate control means for dynamically adapting the sending rate to the current capacity of the transmission channel when said probing is terminated.

4. A receiver intended to receive data sent by a transmitter at an adaptable sending rate through a transmission channel having a time varying capacity, said receiver having data control means for detecting losses and feedback means for reporting said losses to the transmitter, characterized in that, said sending rate is repeatedly raised for probing the transmission channel until a loss is reported by the receiver, said receiver is designed for reporting a fake loss when the sending rate has risen to the current capacity of the transmission channel so as to force the transmitter to terminate said probing.

5. A receiver as claimed in claim 4, characterized in that it is further designed to compute a received rate that is an estimation of the rate at which data are received, and to monitor the evolution of said received rate for deciding whether the sending rate has risen to the current capacity of the transmission channel.

6. A rate control method to be used for transmitting data from a transmitter having an adaptable sending rate to a receiver designed for detecting losses and reporting losses to said transmitter, through a transmission channel having a time varying capacity, said rate control method comprising the steps of:
repeatedly raising the sending rate for probing the transmission channel until a loss is reported by the receiver,
reporting of a fake loss when the sending rate has risen to the current capacity of the transmission channel so as to force the transmitter to terminate said probing phase.

7. A rate control method as claimed in claim 6, characterized in that it further comprises a step of calculating a received rate at the receiver, said received rate being an estimation of the rate at which data are received, and a step of monitoring the evolution of said received rate for deciding whether the transmitter sending rate has risen to the current capacity of the transmission channel.

8. A program comprising instructions for implementing the receiver steps of a rate control method as claimed in claims 6 or 7, when said program is executed by a processor.
